(19) United States
(12) Patent Application Publication
(10) Pub. No.: US 2023/0116643 A1
(43) Pub. Date: Apr. 13, 2023

(54) Conditioning of Multi-Component CO2 Containing Gaseous Streams in CO2 Sequestering Processes

(71) Applicant: Blue Planet Systems Corporation, Los Gatos, CA (US)

(72) Inventors: Kyle Self, Los Gatos, CA (US); Jacob Schneider, San Jose, CA (US); Brent R. Constantz, Portola Valley, CA (US)

(21) Appl. No.: 17/952,702

(22) Filed: Sep. 26, 2022

Related U.S. Application Data
(60) Provisional application No. 63/250,836, filed on Sep. 30, 2021.

(51) Int. Cl. B01D 51/10; B01D 53/62; B01D 53/81; C01B 32/60

(52) U.S. Cl. CPC B01D 51/10; B01D 53/62; B01D 53/81; C01B 32/60; B01D 2258/0283; B01D 2257/504; B01D 2251/606

(57) ABSTRACT

Methods and systems for conditioning a CO₂ containing multi-component gaseous stream for use in a CO₂ sequestration process are provided. Aspects of the methods include cooling the CO₂ containing multi-component gaseous stream and/or removing physical components (such as, moisture, particulates, and pollutants) to condition the CO₂ containing multi-component gaseous stream.

### CROSS-REFERENCE TO RELATED APPLICATIONS

Pursuant to 35 U.S.C. § 119(e), this application claims priority to the filing date of U.S. Provisional Application Ser. No. 63/250,836 filed on Sep. 30, 2021; the disclosure of which applications is herein incorporated by reference.

### INTRODUCTION

Carbon dioxide (CO₂) is a naturally occurring chemical compound that is present in Earth's atmosphere as a gas. Sources of atmospheric CO₂ are varied and include humans and other living organisms that produce CO₂ in the process of respiration, as well as other naturally occurring sources, such as volcanoes, hot springs, and geysers. Additional major sources of atmospheric CO₂ include industrial plants. Many types of industrial plants (including cement plants, refineries, steel mills and power plants) combust or otherwise react with various carbon-based fuels, such as fossil fuels and syngases in such a manner as to produce CO₂. Fossil fuels that are employed include coal, natural gas, oil, petroleum coke and biofuels. Fuels are also derived from tar sands, oil shale, coal liquids, and coal gasification and biofuels that are made via syngas.

The environmental effects of CO₂ are of significant interest. CO₂ is commonly viewed as a greenhouse gas. Because human activities since the industrial revolution have rapidly increased concentrations of atmospheric CO₂, anthropogenic CO₂ has been implicated in global warming and climate change, as well as increasing oceanic bicarbonate concentration. Ocean uptake of fossil fuel CO₂ is now proceeding at about 1 million metric tons of CO₂ per hour.

Concerns over anthropogenic climate change and ocean acidification have fueled an urgency to discover scalable, cost effective, methods of carbon capture and sequestration (CCS). Typically, methods of CCS separate pure CO₂ from complex flue streams, compress the purified CO₂, and finally inject it into underground saline reservoirs for geologic sequestration. These multiple steps are very energy and capital intensive.

### SUMMARY

Methods of conditioning a CO₂ containing multi-component gaseous stream for use in a CO₂ sequestration process are provided. Aspects of the methods include modifying the CO₂ containing multi-component gaseous stream to condition the CO₂ containing multi-component gaseous stream for use in a CO₂ sequestration process. Also provided are systems for practicing the methods.

### BRIEF DESCRIPTION OF THE FIGURES

FIG. 1 illustrates a method for conditioning an elevated temperature CO₂ containing multi-component gaseous stream for use in a CO₂ sequestration process according to one embodiment.

FIG. 2 illustrates a method for cooling an elevated temperature CO₂ containing multi-component gaseous stream for use in a CO₂ sequestration process according to one embodiment.

FIG. 3 illustrates one embodiment of a system for conditioning an elevated temperature CO₂ containing multi-component gaseous stream for use in a CO₂ sequestration process.

FIG. 4 illustrates another embodiment of a system for conditioning an elevated temperature CO₂ containing multi-component gaseous stream for use in a CO₂ sequestration process.

### DETAILED DESCRIPTION

Methods of conditioning a CO₂ containing multi-component gaseous stream for use in a CO₂ sequestration process are provided. Aspects of the methods include modifying the CO₂ containing multi-component gaseous stream to condition the CO₂ containing multi-component gaseous stream for use in a CO₂ sequestration process. Also provided are systems for practicing the methods.

Before the present invention is described in greater detail, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Certain ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating unrecited number may be a number which, in the context in which it is presented, provides the substantial equivalent of the specifically recited number.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

While the apparatus and method has or will be described for the sake of grammatical fluidity with functional explanations, it is to be expressly understood that the claims, unless expressly formulated under 35 U.S.C. § 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 U.S.C. § 112 are to be accorded full statutory equivalents under 35 U.S.C. § 112.

### Methods

As summarized above, aspects of the invention include methods of conditioning a CO₂ containing multi-component gaseous stream for use in a CO₂ sequestration process. By “conditioning” is meant altering or changing the CO₂ containing multi-component gaseous stream in some way that that is beneficial with respect to its use in a CO₂ sequestration process. In other words, conditioning means changing the CO₂ containing multi-component gaseous stream in a manner that improves a CO₂ sequestration process which employs the CO₂ containing multi-component gaseous stream. The nature of the improvement may vary, where types of improvements include, but are not limited to: CO₂ sequestration efficiency, energy efficiency, capital efficiency and the like.

The CO₂ containing multi-component gaseous stream may be any gas that includes CO₂ combined with one or more other gasses and/or particulate components, depending upon the source. In certain embodiments, the CO₂ containing multi-component gaseous stream is obtained from an industrial plant, e.g., where the CO₂ containing multi-component gaseous stream is a waste feed from an industrial plant. Industrial plants from which the CO₂ containing multi-component gaseous stream may be obtained, e.g., as a waste feed from the industrial plant, may vary. Industrial plants of interest include, but are not limited to, power plants and industrial product manufacturing plants, such as, but not limited to, chemical and mechanical processing plants, refineries, cement plants, steel plants, etc., as well as other industrial plants that produce CO₂ as a byproduct of fuel combustion or other processing step (such as calcination by a cement plant or reformation by a hydrogen producing facility). Waste feeds of interest include gaseous streams that are produced by an industrial plant, for example as a secondary or incidental product, of a process carried out by the industrial plant.

Of interest in certain embodiments are waste streams produced by industrial plants that combust fossil fuels, e.g., coal, oil, natural gas, as well as man-made fuel products of naturally occurring organic fuel deposits, such as but not limited to tar sands, heavy oil, oil shale, etc. In certain embodiments, power plants are pulverized coal power plants, supercritical coal power plants, mass burn coal power plants, fluidized bed coal power plants, gas or oil-fired boiler and steam turbine power plants, gas or oil-fired boiler simple cycle gas turbine power plants, and gas or oil-fired boiler combined cycle gas turbine power plants. Of interest in certain embodiments are waste streams produced by power plants that combust syngas, i.e., gas that is produced by the gasification of organic matter, e.g., coal, biomass, etc., where in certain embodiments such plants are integrated gasification combined cycle (IGCC) plants. Of interest in certain embodiments are waste streams produced by Heat Recovery Steam Generator (HRSG) plants, where in certain embodiments such plants are combined-cycle cogeneration facilities typically referred to as combined heat and power (CHP) plants. Waste streams of interest also include waste streams produced by cement plants. Cement plants whose waste streams may be employed in methods of the invention include both wet process and dry process plants, which plants may employ shaft kilns or rotary kilns, and may include pre-calciners. Other industrial plants such as smelters and refineries are also useful sources of waste streams that include carbon dioxide. Each of these types of industrial plants may burn a single fuel or may burn two or more fuels sequentially or simultaneously. A waste stream of interest is industrial plant exhaust gas, e.g., a flue gas. By “flue gas” is meant a gas that is obtained from the products of combustion from burning a fossil or biomass fuel that are then directed to the smokestack, also known as the flue of an industrial plant.

Industrial waste gas streams may contain carbon dioxide as the primary non-air derived component, and may, especially in the case of coal-fired power plants, contain additional components (which may be collectively referred to as non-CO₂ pollutants) such as nitrogen oxides (NOx), sulfur oxides (SOx), and one or more additional gases. Additional gases and other components may include CO, mercury and other heavy metals, and dust particles (e.g., from calcining and combustion processes). Additional non-CO₂ pollutant components in the gas stream may also include halides such as hydrogen chloride and hydrogen fluoride; particulate matter such as fly ash, dusts, and metals including arsenic, beryllium, boron, cadmium, chromium, chromium VI, cobalt, lead, manganese, mercury, molybdenum, selenium, strontium, thallium, and vanadium;

and organics such as hydrocarbons, dioxins, and PAH compounds. Suitable gaseous waste streams that may be treated have, in some embodiments, CO₂ present in amounts of 200 ppm to 999,999 ppm; or 200 ppm to 500,000 ppm; or 200 ppm to 100,000 ppm; or 200 ppm to 10,000; or 200 ppm to 5,000 ppm; or 200 ppm to 2000 ppm; or 200 ppm to 1000 ppm; or 200 to 500 ppm; or 500 ppm to 999,999 ppm; or 500 ppm to 500,000 ppm; or 500 ppm to 100,000 ppm; or 500 ppm to 10,000; or 500 ppm to 5,000 ppm; or 500 ppm to 2000 ppm; or 500 ppm to 1000 ppm; or 1000 ppm to 999,999 ppm; or 1000 ppm to 500,000 ppm; or 1000 ppm to 100,000 ppm; or 1000 ppm to 10,000; or 1000 ppm to 5,000 ppm; or 1000 ppm to 2000 ppm; or 2000 ppm to 999,999 ppm; or 2000 ppm to 500,000 ppm; or 2000 ppm to 100,000 ppm; or 2000 ppm to 10,000; or 2000 ppm to 5,000 ppm; or 2000 ppm to 3000 ppm; or 5000 ppm to 999,999 ppm; or 5000 ppm to 500,000 ppm; or 5000 ppm to 100,000 ppm; or 5000 ppm to 10,000; or 10,000 ppm to 999,999 ppm; or 10.00 ppm to 500,000 ppm; or 10,000 ppm to 100,000 ppm; or 50,000 ppm to 999,999 ppm; or 50,000 ppm to 500,000 ppm; or 50,000 ppm to 100,000 ppm; or 100,000 ppm to 999,999 ppm; or 100,000 ppm to 500,000 ppm; or 200,000 ppm to 1000 ppm, including 200,000 ppm to 2000 ppm, for example 180,000 ppm to 2000 ppm, or 180,000 ppm to 5000 ppm, also including 180,000 ppm to 10,000 ppm.

The waste streams, particularly various waste streams of combustion gas, may include one or more additional non-CO₂ components, for example only, water, NOx (mononitrogen oxides: NO and NO₂), SOx (monosulfur oxides: SO, SO₂ and SO₃), VOC (volatile organic compounds), heavy metals such as, but not limited to, mercury, and particulate matter (particles of solid or liquid suspended in a gas). Flue gas temperature may also vary. In some embodiments, the temperature of the flue gas comprising CO₂ is from 0° C. to 2000° C., or 0° C. to 1000° C., or 0° C. to 500° C., or 0° C. to 100° C., or 0° C. to 50° C., or 10° C. to 2000° C., or 10° C. to 1000° C., or 10° C. to 500° C., or 10° C. to 100° C., or 10° C. to 50° C., or 50° C. to 2000° C., or 50° C. to 1000° C., or 50° C. to 500° C., or 50° C. to 100° C., or 100° C. to 2000° C., or 100° C. to 1000° C., or 100° C. to 500° C., or 500° C. to 2000° C., or 500° C. to 1000° C., or 500° C. to 800° C., or such as from 60° C. to 700° C., and including 100° C. to 400° C.

Another gaseous source of CO₂ is a direct air capture (DAC) generated gaseous source of CO₂. The DAC generated gaseous source of CO₂ is a product gas produced by a direct air capture (DAC) system. DAC systems are a class of technologies capable of separating carbon dioxide CO₂ directly from ambient air. A DAC system is any system that captures CO₂ directly from air and generates a product gas that includes CO₂ at a higher concentration than that of the air that is input into the DAC system. While the concentration of CO₂ in the DAC generated gaseous source of CO₂ may vary, in some instances the concentration 1,000 ppm or greater, such as 10,000 ppm or greater, including 100,000 ppm or greater, where the product gas may not be pure CO₂, such that in some instances the product gas is 3% or more non-CO₂ constituents, such as 5% or more non-CO₂ constituents, including 10% or more non-CO₂ constituents. Non-CO₂ constituents that may be present in the product stream may be constituents that originate in the input air and/or from the DAC system. In some instances, the concentration of CO₂ in the DAC product gas ranges from 1,000 to 999,000 ppm, such as 1,000 to 10,000 ppm, or 10,000 to 100,000 ppm or 100,000 to 999,000 ppm. DAC generated gaseous streams have, in some embodiments, CO₂ present in amounts of 200 ppm to 999,999 ppm; or 200 ppm to 500,000 ppm; or 200 ppm to 100,000 ppm; or 200 ppm to 10,000; or 200 ppm to 5,000 ppm; or 200 ppm to 2000 ppm; or 200 ppm to 1000 ppm; or 200 to 500 ppm; or 500 ppm to 999,999 ppm; or 500 ppm to 500,000 ppm; or 500 ppm to 100,000 ppm; or 500 ppm to 10,000; or 500 ppm to 5,000 ppm; or 500 ppm to 2000 ppm; or 500 ppm to 1000 ppm; or 1000 ppm to 999,999 ppm; or 1000 ppm to 500,000 ppm; or 1000 ppm to 100,000 ppm; or 1000 ppm to 10,000; or 1000 ppm to 5,000 ppm; or 1000 ppm to 2000 ppm; or 2000 ppm to 999,999 ppm; or 2000 ppm to 500,000 ppm; or 2000 ppm to 100,000 ppm; or 2000 ppm to 10,000; or 2000 ppm to 5,000 ppm; or 2000 ppm to 3000 ppm; or 5000 ppm to 999,999 ppm; or 5000 ppm to 500,000 ppm; or 5000 ppm to 100,000 ppm; or 5000 ppm to 10,000; or 10,000 ppm to 999,999 ppm; or 10.00 ppm to 500,000 ppm; or 10,000 ppm to 100,000 ppm; or 50,000 ppm to 999,999 ppm; or 50,000 ppm to 500,000 ppm; or 50,000 ppm to 100,000 ppm; or 100,000 ppm to 999,999 ppm; or 100,000 ppm to 500,000 ppm; or 200,000 ppm to 1000 ppm, including 200,000 ppm to 2000 ppm, for example 180,000 ppm to 2000 ppm, or 180,000 ppm to 5000 ppm, also including 180,000 ppm to 10,000 ppm.

The DAC product gas may be produced by any convenient DAC system. DAC systems are systems that extract CO₂ from the air using media that binds to CO₂ but not to other atmospheric chemicals (such as nitrogen and oxygen). As air passes over the CO₂ binding medium, CO₂ “sticks” to the binding medium. In response to a stimulus, e.g., heat, humidity, etc., the bound CO₂ may then be released from the binding medium resulting the production of a gaseous CO₂ containing product. DAC systems of interest include, but are not limited to: hydroxide based systems; CO₂ sorbent/temperature swing based systems, and CO₂ sorbent/temperature swing based systems. In some instances, the DAC system is a hydroxide-based system, in which CO₂ is separated from air by contacting the air with is an aqueous hydroxide liquid. Examples of hydroxide-based DAC systems include, but are not limited to, those described in PCT published application Nos. WO/2009/155539; WO/2010/022339; WO/2013/036859; and WO/2013/120024; the disclosures of which are herein incorporated by reference. In some instances, the DAC system is a CO₂ sorbent-based system, in which CO₂ is separated from air by contacting the air with sorbent, such as an amine sorbent, followed by release of the sorbent captured CO₂ by subjecting the sorbent to one or more stimuli, e.g., change in temperature, change in humidity, etc. Examples of such DAC systems include, but are not limited to, those described in PCT published application Nos. WO/2005/108297; WO/2006/009600; WO/2006/023743; WO/2006/036396; WO/2006/084008; WO/2007/016271; WO/2007/114991; WO/2008/042919; WO/2008/061210; WO/2008/131132; WO/2008/144708; WO/2009/061836; WO/2009/067625; WO/2009/105566; WO/2009/149292; WO/2010/019600; WO/2010/022399; WO/2010/107942; WO/2011/011740; WO/2011/137398; WO/2012/106703; WO/2013/028688; WO/2013/075981; WO/2013/166432; WO/2014/170184; WO/2015/103401; WO/2015/185434; WO/2016/005226; WO/2016/037668; WO/2016/162022; WO/2016/164563; WO/2016/161998; WO/2017/184652; and WO/2017/009241; the disclosures of which are herein incorporated by reference.

Further details regarding DAC generated gaseous sources of CO₂ and their use in CO₂ sequestration processes may be found in PCT application serial no. PCT/US2018/020527 published as WO/2018/160888, the disclosure of which is herein incorporated by reference.

Conditioning of CO₂ containing multi-component gaseous streams in embodiments of the invention includes modifying the CO₂ containing multi-component gaseous streams. Depending on the particular embodiment of the invention, the modifying may vary. In some instances, modifying includes removing one or more physical components of the CO₂ containing multi-component gaseous stream. Physical component may include moisture, a particulate, a pollutant, etc. In embodiments of the invention, one or more of these components may be removed. In some embodiments, in addition to a physical component, e.g., moisture, a particulate and/or pollutant, energy, e.g., heat, is removed from the CO₂ containing multi-component gaseous stream. In yet other embodiments, just heat is be removed from the CO₂ containing multi-component gaseous stream.

Accordingly, in some embodiments the modifying includes removing one or more physical components of the CO₂ containing multi-component gaseous stream. In such instances, the physical components that are removed from the CO₂ containing multi-component gaseous stream may vary. Examples of such physical components include but are not limited to: moisture (H₂O); particulates, e.g., ashes and dusts, where such particulates may vary in size, ranging in some instances from 5 to 500 um, such as 10 to 100 um; pollutants, e.g., SOx, NOx, carbon monoxide (CO), mercury (Hg) and the like, as well as combinations thereof. In such embodiments, the amount of removal of a given physical component may vary, and in some embodiments is 5% or more, such as 10% or more, including 20% or more, e.g., 25% or more, 50% or more, including 75% or more.

In some embodiments, conditioning of the CO₂ containing multi-component gaseous stream includes removing heat from the CO₂ containing multi-component gaseous stream. In these embodiments, conditioning may be viewed as cooling the CO₂ containing multi-component gaseous stream. In such instances, the CO₂ containing multi-component gaseous stream may be an elevated temperature CO₂ containing multi-component gaseous stream. By elevated temperature CO₂ containing multi-component gaseous stream is meant a gaseous stream that has a temperature of 150° F. or higher, such as 200° F. or higher, including 275° F. or higher. In some instances, the elevated temperature CO₂ containing multi-component gaseous stream has a temperature that is 1,200° F. or lower, such as 350° F. or lower.

In such embodiments, the temperature of the CO₂ containing multi-component gaseous stream may be reduced by any desired amount. In some instances, the cooling of the CO₂ containing multi-component gaseous stream includes reducing the temperature of the CO₂ containing multi-component gaseous stream by 1,000° F. or more, such as 400° F. or more, including 250° F. or more. In some instances, the CO₂ containing multi-component gaseous stream is cooled by an amount of 150° F. or less, such as 100° F. or less.

In embodiments where the CO₂ containing multi-component gaseous stream is cooled, cooling may be achieved using any convenient protocol. For example, in some instances cooling may be achieved using a heat exchanger. The term “heat exchanger” is used in its conventional sense to refer to any system known to those familiar with the art, including but not limited to a heat sink system, a counter-current system, a co-current system, a cross-current system, and the like. Any convenient heat exchanger may be employed, such as, but not limited to conventional type non-contact heat exchanger systems such as shell-and-tube heat exchangers. Heat obtained from the elevated temperature CO₂ containing multi-component gaseous stream by the heat exchanger may, in some instances, be further employed as desired, e.g., in a CO₂ sequestration process, such as described in greater below, e.g., where heat obtained by the heat exchanger is employed to heat aggregate for use in a CO₂ sequestration process, such as described below.

In some embodiments, the CO₂ containing multi-component gaseous stream is cooled by contacting the CO₂ containing multi-component gaseous stream with an aggregate. The term “aggregate” is used in its conventional sense to refer to a granular material, i.e., a material made up of grains or particles. The size of the constituent particles of the aggregate may vary, where in some instances the size ranges from 0.001 to 100 mm, such as 1 to 10 mm and including 5 to 50 mm. The aggregate may be naturally occurring or synthetic, as desired. In some embodiments the aggregate may be a recycled aggregate. The recycled aggregate, in some instances, may be recycled from ready-mix concrete applications, concrete and demolition waste applications, roadway improvement applications, construction project applications. In some embodiments the aggregate may a landfilled material. The landfilled material, in some instances, may be co-located at the site of an industrial plant. In other embodiments of the invention the aggregate may be a geomass. Geomass that may be employed as an aggregate of the invention are further described in PCT published application No. WO/2020/047243; the disclosure of which is herein incorporated by reference. The contacting may vary as desired, and may be static or continuous. In some instances, the contacting is continuous, e.g., where the CO₂ containing multi-component gaseous stream is flowed relative to the aggregate, which aggregate may be static or also moving. The aggregate may be in a dry or wet state, e.g., where an amount of aqueous liquid (e.g., water) is present on the surfaces of the aggregate. In such instances, the flow rate of the CO₂ containing multi-component gaseous stream may vary, and in some instances the flow rate ranges from 1,000 to 10,000,000 lb/hr, such as 3,000 to 300,000 lb/hr and including 500,000 to 5,000,000 lb/hr. The aggregate may also be moving, where in some instances the aggregate moves at a rate of 500 to 5,000,000 lb/hr such as 1,000 to 100,000 lb/hr. Where both the CO₂ containing multi-component gaseous stream and aggregate are moving, they may be contacted with each other in a counter-current, cross-current, or co-current manner as desired. The rate of movement of the CO₂ containing multi-component gaseous stream and aggregate may be the same or different, as desired, where when the movement rates are different, the magnitude of any difference may vary, and in some instances ranges from 2 to 500, such as 5 to 60. In those instances where the CO₂ containing multi-component gaseous stream is contacted with an aggregate, the temperature of the initial aggregate may vary. In some instances, the temperature of the initial aggregate ranges from 32 to 100° F., such as 40 to 80° F. Contact of the CO₂ containing multi-component gaseous stream with the aggregate may result in production of warmed aggregate, e.g., an aggregate having a temperature ranging from 65 to 120° F., such as 70 to 110° F. The resultant warmed aggregate may be employed as desired, e.g., as a component of a concrete or building material, etc., including as described below.

CO₂ containing multi-component gaseous streams conditioned in accordance with embodiments of the invention, e.g., as described above, may be employed in CO₂ sequestering processes. By CO₂ sequestering process is meant a process that converts an amount of gaseous CO₂ into a solid carbonate, thereby sequestering CO₂ as a solid mineral. A variety of different CO₂ sequestering processes may be employed to produce a CO₂ sequestering solid. CO₂ sequestering processes in which conditioned CO₂ containing multi-component gaseous streams may be employed include, but are not limited to, those processes that remove CO₂ from the multi-component gaseous stream and produce a CO₂ sequestering solid therefrom. CO₂ sequestering solids that may be treated in accordance with embodiments of the invention may vary. By “CO₂ sequestering” is meant that the material has been produced from CO₂, e.g., that is derived from a fuel source used by humans, including atmospheric CO₂ that may be derived from human activities, or from natural sources, such as plant decay by microorganisms, where the mixture of human-derived fossil fuel CO₂ from combustion of fossil fuel and that from decay both have a plant derived source where the CO₂ was originally derived from photosynthesis. For example, in some embodiments, a CO₂ sequestering material is produced from CO₂ that is obtained from the combustion of a fossil fuel, e.g., in the production of electricity. Examples of sources of such CO₂ include, but are not limited to, power plants, industrial manufacturing plants, etc., which combust fossil fuels and produce CO₂, e.g., in the form of a CO₂ containing gas or gases. Examples of fossil fuels include, but are not limited to, oils, coals, natural gasses, tar sands, rubber tires, biomass, shred, etc. Further details on how to produce a CO₂ sequestering material are provided below.

The CO₂ sequestering materials may have an isotopic profile that identifies the component as being of fossil fuel origin or from modern plants, both fractionating the CO₂ during photosynthesis, and therefore as being CO₂ sequestering. For example, in some embodiments the carbon atoms in the CO₂ materials reflect the relative carbon isotope composition (δ¹³C) of the fossil fuel (e.g., coal, oil, natural gas, tar sand, trees, grasses, agricultural plants) from which the plant-derived CO₂, both fossil or modern, that was used to make the material was derived. In addition to, or alternatively to, carbon isotope profiling, other isotopic profiles, such as those of oxygen (δ¹⁸O), nitrogen (δ¹⁵N), sulfur (δ³⁴S), and other trace elements may also be used to identify a fossil fuel source that was used to produce an industrial CO₂ source from which a CO₂ sequestering material is derived. For example, another marker of interest is (δ¹⁸O). Isotopic profiles that may be employed as an identifier of CO₂ sequestering materials of the invention are further described in U.S. Pat. No. 9,714,406; the disclosure of which is herein incorporated by reference.

CO₂ sequestering solid compositions provide for long-term storage of CO₂ in a manner such that CO₂ is sequestered (i.e., fixed) in the material, wherein the sequestered CO₂ does not become part of the atmosphere. When the solid composition is maintained under conditions convention for its intended use, the solid composition keeps sequestered CO₂ fixed for extended periods of time, such as 1 year or longer, 5 years or longer, 10 years or longer, 25 years or longer, or 50 years or longer, with significant, if any, release of CO₂ from the solid composition. For instance, when the solid composition is maintained in a manner consistent with its intended use, the amount of CO₂ gas released from the solid composition is 10% or less of the total amount of CO₂ in the solid composition per year, such as 5% or less or 1% or less when exposed to normal conditions of temperature and moisture, including rainfall of normal pH, for there intended use, for at least 1, 2, 5, 10, or 20 years, or for more than 20 years, for example, for more than 100 years. Any suitable surrogate marker or test that is reasonably able to predict such stability may be used. For example, an accelerated test comprising conditions of elevated temperature and/or moderate to more extreme pH conditions is reasonably able to indicate stability over extended periods of time. For example, depending on the intended use and environment of the composition, a sample of the initial CO₂ sequestering solid composition may be exposed to 50, 75, 90, 100, 120, or 150° C. for 1, 2, 5, 25, 50, 100, 200, or 500 days at between 10% and 50% relative humidity, and a loss less than 1%, 2%, 3%, 4%, 5%, 10%, 20%, 30%, or 50% of its carbon may be considered sufficient evidence of stability of the solid composition for a given period (e.g., 1, 10, 100, 1000, or more than 1000 years).

The term “solid” in “CO₂ sequestering solid” means that there are one or more compounds in the solid state of matter. In other words, at least a part, if not all, of the CO₂ sequestering solid is in the solid state of matter. In some cases, the solid includes a solid and a liquid, while in some cases, the solid composition includes a solid but no liquid, i.e., the solid is a dry solid. In some cases, the solid of the solid composition includes a “precipitate”, which is a solid that is formed by a chemical reaction. For example, the precipitate can be a CO₂ sequestering precipitate, e.g., it can include a carbonate compound. For instance, if gaseous CO₂ is contacted with an aqueous solution including a cation source, then one possible product is solid particles including a carbonate compound formed by the chemical reaction between the cation source and the gaseous CO₂. Since the particles are formed by the chemical reaction between CO₂ and cation source, they are referred to herein as a precipitate. If this precipitate is subjected to a physical manipulation that changes the size, shape, or both of the solid, then the resulting solid is referred to as an “aggregate”. In some cases, the aggregate is a solid resulting from a manipulation that increased the size of the precipitate solid, e.g., an aggregate with a larger length, width, height, diameter, or a combination thereof compared to the precipitate. In some cases, forming the precipitate into an aggregate includes removal of a component, such as separation of water from the precipitate by filtration or drying. In some cases, forming the precipitate into aggregate includes addition of a component, such as adding a binding compound. For example, the precipitate can be combined with cement to form concrete aggregates. The term “aggregate” is used in its conventional sense to refer to a granular material, i.e., a material made up of grains or particles. As the aggregate is a carbonate aggregate, such as a calcium carbonate aggregate, the particles of the granular material include one or more carbonate compounds, where the carbonate compound(s) component may be combined with other substances (e.g., substrates) or make up the entire particles, as desired. Other methods that may be employed to produce an aggregate CO₂ sequestering solid are further described in U.S. Provisional Application Ser. No. 63/128,487 (Attorney Docket BLUE-048PRV); the disclosure of which is herein incorporated by reference.

In some instances, an ammonia mediated CO₂ sequestering process is employed to produce the CO₂ sequestering solid. Embodiments of such methods include multistep or single step protocols, as desired. For example, in some embodiments, combination of a CO₂ capture liquid and gaseous source of CO₂ results in production of an aqueous carbonate, which aqueous carbonate is then subsequently contacted with a divalent cation source, e.g., a Ca²⁺ and/or Mg²⁺ source, to produce the carbonate slurry. In yet other embodiments, a one-step CO₂ gas absorption carbonate precipitation protocol is employed.

As summarized above, in some CO₂ sequestering processes of embodiments of the invention, an aqueous capture liquid is contacted with a conditioned CO₂ multi-component gaseous stream produced in accordance with an embodiment of the invention under conditions sufficient to produce an aqueous carbonate. The aqueous capture liquid may vary. Examples of aqueous capture liquids include, but are not limited to fresh water to bicarbonate buffered aqueous media. Bicarbonate buffered aqueous media employed in embodiments of the invention include liquid media in which a bicarbonate buffer is present. The bicarbonate buffered aqueous medium may be a naturally occurring or man-made medium, as desired. Naturally occurring bicarbonate buffered aqueous media include, but are not limited to, waters obtained from seas, oceans, lakes, swamps, estuaries, lagoons, brines, alkaline lakes, inland seas, etc. Man-made sources of bicarbonate buffered aqueous media may also vary, and may include brines produced by water desalination plants, and the like. Further details regarding such capture liquids are provided in U.S. Pat. Nos. 9,714,406; 10,203,434 and 9,993,799; the disclosures of which applications are herein incorporated by reference.

In some embodiments, an aqueous capture ammonia is contacted with the gaseous source of CO₂ under conditions sufficient to produce an aqueous ammonium carbonate. The concentration of ammonia in the aqueous capture ammonia may vary, where in some instances the aqueous capture ammonia includes ammonia (NH₃) at a concentration ranging from 10 ppm to 350,000 ppm NH₃, such as 10 to 10,000 ppm, or 10 to 1,000 ppm, or 10 to 5,000 ppm, or 10 to 8,000 ppm, or 10 to 10,000 ppm, or 100 to 100,000 ppm, or 100 to 10,000 ppm, or 100 to 50,000 ppm, or 100 to 80,000 ppm, or 100 to 100,000 ppm, or 1,000 to 350,000 ppm, or 1,000 to 50,000 ppm, or 1,000 to 80,000 ppm, or 1,000 to 100,000 ppm, or 1,000 to 200,000 ppm, or 1,000 to 350,000 ppm, or such as from 6,000 to 85,000 ppm, and including 8,000 to 50,000 ppm. The aqueous capture ammonia may include any convenient water. Waters of interest from which the aqueous capture ammonia may be produced include, but are not limited to, freshwaters, seawaters, brine waters, reclaimed or recycled waters, produced waters and waste waters. The pH of the aqueous capture ammonia may vary, ranging in some instances from 9.0 to 13.5, such as 9.0 to 13.0, including 10.5 to 12.5. Further details regarding aqueous capture ammonias of interest are provided in U.S. Pat. No. 10,322,371; the disclosure of which is herein incorporated by reference.

The conditioned CO₂ containing multi-component gaseous stream, e.g., as described above, may be contacted with the aqueous capture liquid, e.g., aqueous capture ammonia, using any convenient protocol. For example, contact protocols of interest include, but are not limited to: direct contacting protocols, e.g., bubbling the gas through a volume of the aqueous medium, co-current contacting protocols, i.e., contact between unidirectionally flowing gaseous and liquid phase streams, countercurrent protocols, i.e., contact between cross flowing gaseous and liquid phase streams, and the like. Contact may be accomplished through use of infusers, bubblers, fluidic Venturi reactors, spargers, gas filters, sprays, trays, scrubbers, absorbers or packed column reactors or bubble column reactors, and the like, as may be convenient. In some instances, the contacting protocol may use a conventional absorber or an absorber froth column, such as those described in U.S. Pat. Nos. 7,854,791; 6,872,240; and 6,616,733; and in United States Patent Application Publication US-2012-0237420-A1; the disclosures of which are herein incorporated by reference. The process may be a batch or continuous process. In some instances, a regenerative froth contactor (RFC) may be employed to contact the CO₂ containing gas with the aqueous capture liquid, e.g., aqueous capture ammonia. In some such instances, the RFC may use a catalyst (such as described elsewhere), e.g., a catalyst that is immobilized on/to the internals of the RFC. Further details regarding a suitable RFC are found in U.S. Pat. No. 9,545,598, the disclosure of which is herein incorporated by reference. In other embodiments the RFC may be supplanted by another reaction vessel, wherein the gas absorption occurs from the intermixing of bubbles and micro-droplets present in a froth created in the reaction vessel.

In some instances, the conditioned CO₂ containing multi-component gaseous stream is contacted with the liquid using a microporous membrane contactor. Microporous membrane contactors of interest include a microporous membrane present in a suitable housing, where the housing includes a gas inlet and a liquid inlet, as well a gas outlet and a liquid outlet. The contactor is configured so that the gas and liquid contact opposite sides of the membrane in a manner such that molecule may dissolve into the liquid from the gas via the pores of the microporous membrane. The membrane may be configured in any convenient format, where in some instances the membrane is configured in a hollow fiber format. Hollow fiber membrane reactor formats which may be employed include, but are not limited to, those described in U.S. Pat. Nos. 7,264,725; 6,872,240 and 5,695,545; the disclosures of which are herein incorporated by reference. In some instances, the microporous hollow fiber membrane contactor that is employed is a hollow fiber membrane contactor, which membrane contactors include polypropylene membrane contactors and polyolefin membrane contactors.

Contact between the capture liquid and the conditioned CO₂ containing multi-component gaseous stream occurs under conditions such that a substantial portion of the CO₂ present in the CO₂-containing gas goes into solution, e.g., to produce bicarbonate ions. By substantial portion is meant 10% or more, such as 50% or more, including 80% or more.

The temperature of the capture liquid that is contacted with the conditioned CO₂ containing multi-component gaseous stream may vary. In some instances, the temperature ranges from −1.4 to 100° C., such as 20 to 80° C. and including 40 to 70° C. In some instances, the temperature may range from −1.4 to 50° C. or higher, such as from −1.1 to 45° C. or higher. In some instances, cooler temperatures are employed, where such temperatures may range from −1.4 to 4° C., such as −1.1 to 0° C. In some instances, warmer temperatures are employed. For example, the temperature of the capture liquid in some instances may be 25° C. or higher, such as 30° C. or higher, and may in some embodiments range from 25 to 50° C., such as 30 to 40° C.

The conditioned CO₂ containing multi-component gaseous stream and the capture liquid are contacted at a pressure suitable for production of a desired CO₂ charged liquid. In some instances, the pressure of the contact conditions is selected to provide for optimal CO₂ absorption, where such pressures may range from 1 ATM to 100 ATM, such as 1 to 50 ATM, e.g., 20-30 ATM or 1 ATM to 10 ATM. Where contact occurs at a location that is naturally at 1 ATM, the pressure may be increased to the desired pressure using any convenient protocol. In some instances, contact occurs where the optimal pressure is present, e.g., at a location under the surface of a body of water, such as an ocean or sea.

In those embodiments where the conditioned CO₂ containing multi-component gaseous stream is contacted with an aqueous capture ammonia, contact is carried out in manner sufficient to produce an aqueous ammonium carbonate. The aqueous ammonium carbonate may vary, where in some instances the aqueous ammonium carbonate comprises at least one of ammonium carbonate and ammonium bicarbonate and in some instances comprises both ammonium carbonate and ammonium bicarbonate. The aqueous ammonium bicarbonate may be viewed as a DIC containing liquid. As such, in charging the aqueous capture ammonia with CO₂, a conditioned CO₂ containing multi-component gaseous stream may be contacted with CO₂ capture liquid under conditions sufficient to produce dissolved inorganic carbon (DIC) in the CO₂ capture liquid, i.e., to produce a DIC containing liquid. The DIC is the sum of the concentrations of inorganic carbon species in a solution, represented by the equation: DIC=[CO₂*]+[HCO₃⁻]+[CO₃²⁻], where [CO₂*] is the sum of carbon dioxide ([CO₂]) and carbonic acid ([H₂CO₃]) concentrations (also just the concentration of dissolved CO₂, such as described below), [HCO₃⁻] is the bicarbonate concentration (which includes ammonium bicarbonate) and [CO₃²⁻] is the carbonate concentration (which includes ammonium carbonate) in the solution. The DIC of the aqueous media may vary, and in some instances may be 3 ppm to 168,000 ppm carbon (C), such as 3 to 1,000 ppm, or 3 to 100 ppm, or 3 to 500 ppm, or 3 to 800 ppm, or 3 to 1,000 ppm, or 100 to 10,000 ppm, or 100 to 1,000 ppm, or 100 to 5,000 ppm, or 100 to 8,000 ppm, or 100 to 10,000 ppm, or 1,000 to 50,000 ppm, or 1,000 to 8,000 ppm, or 1,000 to 15,000 ppm, or 1,000 to 30,000 ppm, or 5,000 to 168,000 ppm, or 5,000 to 25,000 ppm, or such as from 6,000 to 65,000 ppm, and including 8,000 to 95,000 ppm carbon (C). The amount of CO₂ dissolved in the liquid may vary, and in some instances ranges from 0.05 to 40 mM, such as 1 to 35 mM, including 25 to 30 mM. The pH of the resultant DIC containing liquid may vary, ranging in some instances from 4 to 12, such as 6 to 11 and including 7 to 11, e.g., 8 to 9.5.

Where desired, the conditioned CO₂ containing multi-component gaseous stream is contacted with the capture liquid in the presence of a catalyst (i.e., an absorption catalyst, either hetero- or homogeneous in nature) that mediates the conversion of CO₂ to bicarbonate. Of interest as absorption catalysts are catalysts that, at pH levels ranging from 8 to 10, increase the rate of production of bicarbonate ions from dissolved CO₂. The magnitude of the rate increase (e.g., as compared to control in which the catalyst is not present) may vary, and in some instances is 2-fold or greater, such as 5-fold or greater, e.g., 10-fold or greater, as compared to a suitable control. Further details regarding examples of suitable catalysts for such embodiments are found in U.S. Pat. No. 9,707,513, the disclosure of which is herein incorporated by reference.

In some embodiments, the resultant aqueous ammonium carbonate is a two-phase liquid which includes droplets of a liquid condensed phase (LCP) in a bulk liquid, e.g., bulk solution. By “liquid condensed phase” or “LCP” is meant a phase of a liquid solution which includes bicarbonate ions wherein the concentration of bicarbonate ions is higher in the LCP phase than in the surrounding, bulk liquid. LCP droplets are characterized by the presence of a meta-stable bicarbonate-rich liquid precursor phase in which bicarbonate ions associate into condensed concentrations exceeding that of the bulk solution and are present in a non-crystalline solution state. The LCP contains all of the components found in the bulk solution that is outside of the interface. However, the concentration of the bicarbonate ions is higher than in the bulk solution. In those situations where LCP droplets are present, the LCP and bulk solution may each contain ion-pairs and pre-nucleation clusters (PNCs). When present, the ions remain in their respective phases for long periods of time, as compared to ion-pairs and PNCs in solution. Further details regarding LCP containing liquids are provided in U.S. Pat. No. 9,707,513, the disclosure of which is herein incorporated by reference.

As summarized above, both multistep and single step protocols may be employed to produce the CO₂ sequestering carbonate slurry from the CO₂ containing gas the aqueous capture ammonia. For example, in some embodiments the product aqueous ammonium carbonate is forwarded to a CO₂ sequestering carbonate slurry production module, where divalent cations, e.g., Ca²⁺ and/or Mg²⁺, are combined with the aqueous ammonium carbonate to produce the CO₂ sequestering carbonate slurry. In yet other instances, aqueous capture ammonia includes a source of divalent cations, e.g., Ca²⁺ and/or Mg²⁺, such that aqueous ammonium carbonate combines with the divalent cations as it is produced to result in production of a CO₂ sequestering carbonate slurry.

Accordingly, in some embodiments, following production of an aqueous carbonate, such as an aqueous ammonium carbonate, e.g., as described above, the aqueous carbonate is subsequently combined with a cation source under conditions sufficient to produce a solid CO₂ sequestering carbonate. Cations of different valances can form solid carbonate compositions (e.g., in the form of carbonate minerals). In some instances, monovalent cations, such as sodium and potassium cations, may be employed. In other instances, divalent cations, such as alkaline earth metal cations, e.g., calcium (Ca²⁺) and magnesium (Mg²⁺) cations, may be employed. When cations are added to the aqueous carbonate, precipitation of carbonate solids, such as amorphous calcium carbonate (CaCO₃) when the divalent cations include Ca²⁺, may be produced with a stoichiometric ratio of one carbonate-species ion per cation.

Any convenient cation source may be employed in such instances. Cation sources of interest include, but are not limited to, the brine from water processing facilities such as sea water desalination plants, brackish water desalination plants, groundwater recovery facilities, wastewater facilities, blowdown water from facilities with cooling towers, and the like, which produce a concentrated stream of solution high in cation contents. Also of interest as cation sources are naturally occurring sources, such as but not limited to native seawater and geological brines, which may have varying cation concentrations and may also provide a ready source of cations to trigger the production of carbonate solids from the aqueous ammonium carbonate. In some instances, the cation source may be a waste product of another step of the process, e.g., a calcium salt (such as CaCl₂) produced during regeneration of ammonia from the aqueous ammonium salt.

In yet other embodiments, the aqueous capture ammonia includes cations, e.g., as described above. The cations may be provided in the aqueous capture ammonia using any convenient protocol. In some instances, the cations present in the aqueous capture ammonia are derived from a geomass used in regeneration of the aqueous capture ammonia from an aqueous ammonium salt. In addition and/or alternatively, the cations may be provided by combining an aqueous capture ammonia with a cation source, e.g., as described above.

Other CO₂ sequestering carbonate slurry production protocols that may be employed include alkaline intensive protocols, in which a CO₂ containing gas is contacted with an aqueous medium at pH of about 10 or more. Examples of such protocols include, but are not limited to, those described in U.S. Pat. Nos. 8,333,944; 8,177,909; 8,137,455; 8,114,214; 8,062,418; 8,006,446; 7,939,336; 7,931,809; 7,922,809; 7,914,685; 7,906,028; 7,887,694; 7,829,053; 7,815,880; 7,771,684; 7,753,618; 7,749,476; 7,744,761; and 7,735,274; the disclosures of which are herein incorporated by reference.

Following production of an aqueous carbonate, such as an aqueous ammonium carbonate, e.g., as described above, the aqueous carbonate is combined with a cation source under conditions sufficient to produce a solid CO₂ sequestering carbonate. Cations of different valences can form solid carbonate compositions (e.g., in the form of carbonate minerals). In some instances, monovalent cations, such as sodium and potassium cations, may be employed. In other instances, divalent cations, such as alkaline earth metal cations, e.g., calcium and magnesium cations, may be employed. Transition metals may also be employed, e.g., Fe, Mn, Cu, etc. When cations are added to the aqueous carbonate, precipitation of carbonate solids, such as amorphous calcium carbonate when the divalent cations include Ca²⁺, may be produced with a stoichiometric ratio of one carbonate-species ion per cation.

Any convenient cation source may be employed in such instances. Cation sources of interest include, but are not limited to, the brine from water processing facilities such as sea water desalination plants, brackish water desalination plants, groundwater recovery facilities, wastewater facilities, and the like, which produce a concentrated stream of solution high in cation contents. Also of interest as cation sources are naturally occurring sources, such as but not limited to native seawater and geological brines, which may have varying cation concentrations and may also provide a ready source of cations to trigger the production of carbonate solids from the aqueous ammonium carbonate. In some instances, the cation source may be a waste product of another step of the process, e.g., a calcium salt (such as CaCl₂) produced during regeneration of ammonia from the aqueous ammonium salt.

As summarized above, production of CO₂ sequestering carbonate from the aqueous ammonia capture liquid and the gaseous source of CO₂ yields an aqueous ammonium salt. The produced aqueous ammonium salt may vary with respect to the nature of the anion of the ammonium salt, where specific ammonium salts that may be present in the aqueous ammonium salt include, but are not limited to, ammonium chloride, ammonium acetate, ammonium sulfate, ammonium nitrate, etc.

As reviewed above, aspects of the invention further include regenerating an aqueous capture ammonia, e.g., as described above, from the aqueous ammonium salt. By regenerating an aqueous capture ammonium is meant processing the aqueous ammonium salt in a manner sufficient to generate an amount of ammonia from the aqueous ammonium salt. The percentage of input ammonium salt that is converted to ammonia during this regeneration step may vary, ranging in some instances from 1 to 80%, such as 15 to 55%, and in some instances 20 to 80%, e.g., 35 to 55%.

Ammonia may be regenerated from an aqueous ammonium salt in this regeneration step using any convenient regeneration protocol. In some instances, a distillation protocol is employed. While any convenient distillation protocol may be employed, in some embodiments the employed distillation protocol includes heating the aqueous ammonium salt in the presence of an alkalinity source, e.g., geomass, to produce a gaseous ammonia/water product, which may then be condensed to produce a liquid aqueous capture ammonia. In some instances, the protocol happens continuously in a stepwise process wherein contacting the aqueous ammonium salt in the presence of an alkalinity source happens before the distillation and condensation of liquid aqueous capture ammonia.

The alkalinity source may vary, so long as it is sufficient to convert ammonium in the aqueous ammonium salt to ammonia. Any convenient alkalinity source may be employed. Alkalinity sources that may be employed in this regeneration step include chemical agents. Chemical agents that may be employed as alkalinity sources include, but are not limited to, hydroxides, organic bases, super bases, oxides, and carbonates. Hydroxides include chemical species that provide hydroxide anions in solution, including, for example, sodium hydroxide (NaOH), potassium hydroxide (KOH), calcium hydroxide (Ca(OH)₂), or magnesium hydroxide (Mg(OH)₂). Organic bases are carbon-containing molecules that are generally nitrogenous bases including primary amines such as methyl amine, secondary amines such as diisopropylamine, tertiary such as diisopropylethylamine, aromatic amines such as aniline, heteroaromatics such as pyridine, imidazole, and benzimidazole, and various forms thereof. Super bases suitable for use as proton-removing agents include sodium ethoxide, sodium amide (NaNH₂), sodium hydride (NaH), butyl lithium, lithium diisopropylamide, lithium diethylamide, and lithium bis(trimethylsilyl)amide. Oxides including, for example, calcium oxide (CaO), magnesium oxide (MgO), strontium oxide (SrO), beryllium oxide (BeO), and barium oxide (BaO) are also suitable proton-removing agents that may be used.

Also of interest as alkalinity sources are silica sources. The source of silica may be pure silica or a composition that includes silica in combination with other compounds, e.g., minerals, so long as the source of silica is sufficient to impart desired alkalinity. In some instances, the source of silica is a naturally occurring source of silica. Naturally occurring sources of silica include silica containing rocks, which may be in the form of sands or larger rocks. Where the source is larger rocks, in some instances the rocks have been broken down to reduce their size and increase their surface area. Of interest are silica sources made up of components having a longest dimension ranging from 0.01 mm to 1 meter, such as 0.1 mm to 500 cm, including 1 mm to 100 cm, e.g., 1 mm to 50 cm. The silica sources may be surface treated, where desired, to increase the surface area of the sources. A variety of different naturally occurring silica sources may be employed. Naturally occurring silica sources of interest include, but are not limited to, igneous rocks, which rocks include: ultramafic rocks, such as Komatiite, Picrite basalt, Kimberlite, Lamproite, Peridotite; mafic rocks, such as Basalt, Diabase (Dolerite) and Gabbro; intermediate rocks, such as Andesite and Diorite; intermediate felsic rocks, such as Dacite and Granodiorite; and Felsic rocks, such as Rhyolite, Aplite-Pegmatite and Granite. Also of interest are man-made sources of silica. Man-made sources of silica include, but are not limited to, waste streams such as: mining wastes; fossil fuel burning ash; slag, e.g., iron and steel slags, phosphorous slag; cement kiln waste; oil refinery/petrochemical refinery waste, e.g., oil field and methane seam brines; coal seam wastes, e.g. gas production brines and coal seam brine; paper processing waste; water softening, e.g. ion exchange waste brine; silicon processing wastes; agricultural waste; metal finishing waste; high pH textile waste; and caustic sludge. Mining wastes include any wastes from the extraction of metal or another precious or useful mineral from the earth. Wastes of interest include wastes from mining to be used to raise pH, including: red mud from the Bayer aluminum extraction process; the waste from magnesium extraction for sea water, e.g., at Moss Landing, Calif.; and the wastes from other mining processes involving leaching. Ash from processes burning fossil fuels, such as coal fired power plants, create ash that is often rich in silica. In some embodiments, ashes resulting from burning fossil fuels, e.g., coal fired power plants, are provided as silica sources, including fly ash, and bottom ash. Additional details regarding silica sources and their use are described in U.S. Pat. No. 9,714,406; the disclosure of which is herein incorporated by reference.

In embodiments of the invention, ash is employed as an alkalinity source. Of interest in certain embodiments is use of a coal ash as the ash. The coal ash as employed in this invention refers to the residue produced in power plant boilers or coal burning furnaces, for example, chain grate boilers, cyclone boilers and fluidized bed boilers, from burning pulverized anthracite, lignite, bituminous or sub-bituminous coal. Such coal ash includes fly ash which is the finely divided coal ash carried from the furnace by exhaust or flue gases; and bottom ash which collects at the base of the furnace as agglomerates.

Fly ashes are generally highly heterogeneous, and include of a mixture of glassy particles with various identifiable crystalline phases such as quartz, mullite, and various iron oxides. Fly ashes of interest include Type F and Type C fly ash. The Type F and Type C fly ashes referred to above are defined by CSA Standard A23.5 and ASTM C618 as mentioned above. The chief difference between these classes is the amount of calcium, silica, alumina, and iron content in the ash. The chemical properties of the fly ash are largely influenced by the chemical content of the coal burned (i.e., anthracite, bituminous, and lignite). Fly ashes of interest include substantial amounts of silica (silicon dioxide, SiO₂) (both amorphous and crystalline) and lime (calcium oxide, CaO, magnesium oxide, MgO).

The burning of harder, older anthracite and bituminous coal typically produces Class F fly ash. Class F fly ash is pozzolanic in nature, and typically contains less than 20% lime (CaO). Fly ash produced from the burning of younger lignite or subbituminous coal, in addition to having pozzolanic properties, also has some self-cementing properties. In the presence of water, Class C fly ash will harden and gain strength over time. Class C fly ash generally contains more than 20% lime (CaO). Alkali and sulfate (SO₄²⁻) contents are generally higher in Class C fly ashes. In some embodiments it is of interest to use Class C fly ash to regenerate ammonia from an aqueous ammonium salt, e.g., as mentioned above, with the intention of extracting quantities of constituents present in Class C fly ash so as to generate a fly ash closer in characteristics to Class F fly ash, e.g., extracting 95% of the CaO in Class C fly ash that has 20% CaO, thus resulting in a remediated fly ash material that has 1% CaO.

Fly ash material solidifies while suspended in exhaust gases and is collected using various approaches, e.g., by electrostatic precipitators or filter bags. Since the particles solidify while suspended in the exhaust gases, fly ash particles are generally spherical in shape and range in size from 0.5 μm to 100 μm. Fly ashes of interest include those in which at least about 80%, by weight comprises particles of less than 45 microns. Also of interest in certain embodiments of the invention is the use of highly alkaline fluidized bed combustor (FBC) fly ash.

Also of interest in embodiments of the invention is the use of bottom ash. Bottom ash is formed as agglomerates in coal combustion boilers from the combustion of coal. Such combustion boilers may be wet bottom boilers or dry bottom boilers. When produced in a wet or dry bottom boiler, the bottom ash is quenched in water. The quenching results in agglomerates having a size in which 90% fall within the particle size range of 0.1 mm to 20 mm, where the bottom ash agglomerates have a wide distribution of agglomerate size within this range. The main chemical components of a bottom ash are silica and alumina with lesser amounts of oxides of Fe, Ca, Mg, Mn, Na and K, as well as sulphur and carbon.

Also of interest in certain embodiments is the use of volcanic ash as the ash. Volcanic ash is made up of small tephra, i.e., bits of pulverized rock and glass created by volcanic eruptions, less than 2 millimeters in diameter.

In one embodiment of the invention, cement kiln dusts, e.g., bypass dust (BPD) or cement kiln dust (CKD), is employed as an alkalinity source. The nature of the fuel from which the ash and/or dusts were produced, and the means of combustion of said fuel, will influence the chemical composition of the resultant ash and/or dusts. Thus ash and/or dusts may be used as a portion of the means for adjusting pH, or the sole means, and a variety of other components may be utilized with specific ashes and/or dusts, based on chemical composition of the ash and/or dusts.

In certain embodiments of the invention, slag is employed as an alkalinity source. The slag may be used as the sole pH modifier or in conjunction with one or more additional pH modifiers, e.g., ashes, etc. Slag is generated from the processing of metals, and may contain calcium and magnesium oxides as well as iron, silicon and aluminum compounds. In certain embodiments, the use of slag as a pH modifying material provides additional benefits via the introduction of reactive silicon and alumina to the precipitated product. Slags of interest include, but are not limited to, blast furnace slag from iron smelting, slag from electric-arc or blast furnace processing of iron and/or steel (steel slag), copper slag, nickel slag and phosphorus slag.

As indicated above, ash (or slag in certain embodiments) is employed in certain embodiments as the sole way to modify the pH of the water to the desired level. In yet other embodiments, one or more additional pH modifying protocols is employed in conjunction with the use of ash.

Also of interest in certain embodiments is the use of other waste materials, e.g., crushed or demolished or recycled or returned concretes or mortars, as an alkalinity source. When employed, the concrete dissolves releasing sand and aggregate which, where desired, may be recycled to the carbonate production portion of the process. Use of demolished and/or recycled concretes or mortars is further described below.

Of interest in certain embodiments are mineral alkalinity sources. The mineral alkalinity source that is contacted with the aqueous ammonium salt in such instances may vary, where mineral alkalinity sources of interest include, but are not limited to: silicates, carbonates, fly ashes, slags, limes, cement kiln dusts, etc., e.g., as described above. In some instances, the mineral alkalinity source comprises a rock, e.g., as described above. In embodiments, the alkalinity source is a geomass, e.g., as described in greater detail below.

While the temperature to which the aqueous ammonium salt is heated in these embodiments may vary, in some instances the temperature ranges from 25 to 200° C., such as 25 to 185° C. The heat employed to provide the desired temperature may be obtained from any convenient source, including steam, a waste heat source, such as flue gas waste heat, etc. In some embodiments, the aqueous ammonium salt is not heated, e.g., the temperature is ambient temperature.

Distillation may be carried out at any pressure. Where distillation is carried out at atmospheric pressure, the temperature at which distillation is carried out may vary, ranging in some instances from 50 to 140° C., such as 60 to 130° C., e.g., from 90 to 120° C. In some instances, distillation is carried out at a sub-atmospheric pressure. While the pressure in such embodiments may vary, in some instances the sub-atmospheric pressure ranges from 1 to 14 psiq, such as from 2 to 6 psiq. Where distillation is carried out at sub-atmospheric pressure, the distillation may be carried out at a reduced temperature as compared to embodiments that are performed at atmospheric pressure. While the temperature may vary in such instances as desired, in some embodiments where a sub-atmospheric pressure is employed, the temperature ranges from 15 to 100° C., such as 25 to 50° C. Of interest in sub-atmospheric pressure embodiments is the use of a waste heat for some, if not all, of the heat employed during distillation. Waste heat sources of that may be employed in such instances include, but are not limited to: flue gas, process steam condensate, heat of absorption generated by CO₂ capture and resultant ammonium carbonate production; and a cooling liquid (such as from a co-located source of CO₂ containing gas, such as a power plant, factory etc., e.g., as described above), and combinations thereof.

Aqueous capture ammonia regeneration may also be achieved using an electrolysis mediated protocol, in which a direct electric current is introduced into the aqueous ammonium salt to regenerate ammonia. Any convenient electrolysis protocol may be employed. Examples of electrolysis protocols that may be adapted for regeneration of ammonia from an aqueous ammonium salt may employed one or more elements from the electrolysis systems described in U.S. Pat. Nos. 7,727,374 and 8,227,127, as well as published PCT Application Publication No. WO/2008/018928; the disclosures of which are hereby incorporated by reference.

In some instances, the aqueous capture ammonia is regenerated from the aqueous ammonium salt without the input of energy, e.g., in the form of heat and/or electric current, such as described above. In such instances, the aqueous ammonium salt is combined with an alkaline source, such as a geomass source, e.g., as described above, in a manner sufficient to produce a regenerated aqueous capture ammonia. The resultant aqueous capture ammonia is then not purified, e.g., by input of energy, such as via stripping protocol, etc.

In some instances, alkalinity for regeneration is provided by a membrane mediated alkali enrichment protocol, e.g., as described in U.S. Pat. No. 9,707,513, the disclosure of which is herein incorporated by reference. By alkali enrichment protocol mediated methods is meant that the methods employ an alkali enrichment protocol at some point during the method, e.g., to produce a CO₂ capture liquid, to enhance the alkalinity of a CO₂ charged liquid, etc. The alkali enrichment protocol may be employed once or two or more times during a given method, and at different stages of a given method. For example, an alkali enrichment protocol may be performed before and/or after a CO₂ capture liquid production step, e.g., as described in greater detail below.

The resultant regenerated aqueous capture ammonia may vary, e.g., depending on the particular regeneration protocol that is employed. In some instances, the regenerated aqueous capture ammonia includes ammonia (NH₃) at a concentration ranging from 0.1 to 25 moles per liter (M), such as from 4 to 20 M, including from 12.0 to 16.0 M, as well as any of the ranges provided for the aqueous capture ammonia provided above. The pH of the aqueous capture ammonia may vary, ranging in some instances from 10.0 to 13.0, such as 10.0 to 12.5. In some instances, e.g., where the aqueous capture ammonia is regenerated in a geomass mediated protocol that does not include input of energy, e.g., as described above, the regenerated aqueous capture ammonia may further include cations, e.g., divalent cations, such as Ca²⁺. In addition, the regenerated aqueous capture ammonia may further include an amount of ammonium salt. In some instances, ammonia (NH₃) is present at a concentration ranging from 0.05 to 4 moles per liter (M), such as from 0.05 to 1 M, including from 0.1 to 2 M. The pH of the aqueous capture ammonia may vary, ranging in some instances from 8.0 to 11.0, such as from 8.0 to 10.0. The aqueous capture ammonia may further include ions, e.g., monovalent cations, such as ammonium (NH₄⁺) at a concentration ranging from 0.1 to 5 moles per liter (M), such as from 0.1 to 2 M, including from 0.5 to 3 M, divalent cations, such as calcium (Ca²⁺) at a concentration ranging from 0.05 to 2 moles per liter (M), such as from 0.1 to 1 M, including from 0.2 to 1 M, divalent cations, such as magnesium (Mg²⁺) at a concentration ranging from 0.005 to 1 moles per liter (M), such as from 0.005 to 0.1 M, including from 0.01 to 0.5 M, divalent anions, such as sulfate (SO₄²⁻) at a concentration ranging from 0.005 to 1 moles per liter (M), such as from 0.005 to 0.1 M, including from 0.01 to 0.5 M.

Aspects of the methods further include contacting the regenerated aqueous capture ammonia with a gaseous source of CO₂, e.g., as described above, under conditions sufficient to produce a CO₂ sequestering carbonate, e.g., as described above.

In other words, the methods include recycling the regenerated ammonia into the process. In such instances, the regenerated aqueous capture ammonia may be used as the sole capture liquid, or combined with another liquid, e.g., make up water, to produce an aqueous capture ammonia suitable for use as a CO₂ capture liquid. Where the regenerated aqueous ammonia is combined with additional water, any convenient water may be employed. Waters of interest from which the aqueous capture ammonia may be produced include, but are not limited to, freshwaters, seawaters, brine waters, produced waters and waste waters.

In some embodiments an additive is present in the cation source and/or in the aqueous ammonia capture liquid regenerated from the aqueous ammonium salt, e.g., as described below. Additives may include, e.g., ionic species such as magnesium (Mg²⁺), strontium (Sr²⁺), barium (Ba²⁺), radium (Ra²⁺), ammonium (NH₄⁺), sulfate (SO₄²⁻), phosphates (PO₄³⁻, HPO₄²⁻, or H₂PO₄⁻), carboxylate groups such as, e.g., oxylate, carbamate groups such as, e.g., H₂NCOO⁻, transition metal cations such as, e.g., manganese (Mn), copper (Cu), nickel (Ni), zinc (Zn), cadmium (Cd), chromium (Cr). In some instances, the additives are intentionally added to the cation source and/or to the aqueous ammonia capture liquid regenerated from the aqueous ammonium salt. In other instances, the additives are extracted from an alkalinity source, e.g., from geomass such as described above, during some embodiments of the method. In some embodiments the additive has an effect on the reactivity of the CO₂ sequestering carbonate precipitate, for example, in some instances, the calcium carbonate slurry has no detectable calcite morphology, and may be amorphous calcium carbonate (ACC), vaterite, aragonite or other morphology, including any combination of such morphologies.

In some instances, the CO₂ gas/aqueous capture ammonia module comprises a combined capture and alkali enrichment reactor, the reactor comprising: a core hollow fiber membrane component (e.g., one that comprises a plurality of hollow fiber membranes); an alkali enrichment membrane component surrounding the core hollow fiber membrane component and defining a first liquid flow path in which the core hollow fiber membrane component is present; and a housing configured to contain the alkali enrichment membrane component and core hollow fiber membrane component, wherein the housing is configured to define a second liquid flow path between the alkali enrichment membrane component and the inner surface of the housing. In some instances, the alkali enrichment membrane component is configured as a tube and the hollow fiber membrane component is axially positioned in the tube. In some instances, the housing is configured as a tube, wherein the housing and the alkali enrichment membrane component are concentric. Aspects of the invention further include a combined capture and alkali enrichment reactor, e.g., as described above.

Further details regarding the ammonia mediated protocols, including “hot” and “cold” processes, are found in U.S. Pat. No. 10,322,371 and PCT application serial no. PCT/US2019/048790 published as WO 2020/047243, the disclosures of which are herein incorporated by reference.

The product carbonate compositions may vary greatly. The precipitated product may include one or more different carbonate compounds, such as two or more different carbonate compounds, e.g., three or more different carbonate compounds, five or more different carbonate compounds, etc., including non-distinct, amorphous carbonate compounds. Carbonate compounds of precipitated products of the invention may be compounds having a molecular formulation Xₘ(CO₃)ₙ where X is any element or combination of elements that can chemically bond with a carbonate group or its multiple, wherein X is in certain embodiments an alkaline earth metal and not an alkali metal; wherein m and n are stoichiometric positive integers. These carbonate compounds may have a molecular formula of Xₘ(CO₃)ₙ.H₂O, where there are one or more structural waters in the molecular formula. The amount of carbonate in the product, e.g., as determined by coulometry using the protocol described as coulometric titration, may be 10% or more, such as 25% or more, 50% or more, including 60% or more.

The carbonate compounds of the precipitated products may include a number of different cations, such as but not limited to ionic species of: calcium, magnesium, sodium, potassium, sulfur, boron, silicon, strontium, and combinations thereof. Of interest are carbonate compounds of divalent metal cations, such as calcium and magnesium carbonate compounds. Specific carbonate compounds of interest include, but are not limited to: calcium carbonate minerals, magnesium carbonate minerals and calcium magnesium carbonate minerals. Calcium carbonate minerals of interest include, but are not limited to: calcite (CaCO₃), aragonite (CaCO₃), vaterite (CaCO₃), ikaite (CaCO₃.6H₂O), amorphous calcium carbonate (CaCO₃), and any combination of these calcium carbonate minerals such as crystalline carbonate minerals. Magnesium carbonate minerals of interest include, but are not limited to magnesite (MgCO₃), barringtonite (MgCO₃.2H₂O), nesquehonite (MgCO₃.3H₂O), lanfordite (MgCO₃.5H₂O), hydromagnisite, and amorphous magnesium calcium carbonate (MgCO₃). Calcium magnesium carbonate minerals of interest include, but are not limited to dolomite (CaMg)(CO₃)₂), huntite (Mg₃Ca(CO₃)₄) and sergeevite (Ca₂Mg₁₁(CO₃)₁₃.H₂O). Also of interest are carbonate compounds formed with Na, K, Al, Ba, Cd, Co, Cr, As, Cu, Fe, Pb, Mn, Hg, Ni, V, Zn, etc. The carbonate compounds of the product may include one or more waters of hydration, or may be anhydrous. In some instances, the amount by weight of magnesium carbonate compounds in the precipitate exceeds the amount by weight of calcium carbonate compounds in the precipitate. For example, the amount by weight of magnesium carbonate compounds in the precipitate may exceed the amount by weight calcium carbonate compounds in the precipitate by 5% or more, such as 10% or more, 15% or more, 20% or more, 25% or more, 30% or more. In some instances, the weight ratio of magnesium carbonate compounds to calcium carbonate compounds in the precipitate ranges from 1.5-5 to 1, such as 2-4 to 1 including 2-3 to 1. In some instances, the precipitated product may include hydroxides, such as divalent metal ion hydroxides, e.g., calcium and/or magnesium hydroxides.

Further details regarding carbonate production and methods of using the carbonated produced thereby are provided in U.S. Pat. Nos. 9,714,406; 10,711,236; 10,203,434; 9,707,513; 10,287,439; 9,993,799; 10,197,747; and 10,322,371; as well as published PCT Application Publication Nos. WO 2020/047243 and WO 2020/154518; the disclosures of which are herein incorporated by reference.

In some embodiments, the method further includes setting the initial CO₂ sequestering solid composition. As discussed above, the initial CO₂ sequestering solid composition can include not only compounds in the solid state, but also compounds in a liquid state, e.g., liquid water. “Setting” the initial CO₂ sequestering solid composition is used interchangeably with “air drying” the solid composition and includes placing the solid composition in an environment such that there is evaporation of liquid from the solid composition. By removing a liquid from the solid composition, the chemical composition and thereby physical properties of the solid composition can be altered, e.g., a reduced volume of liquid can cause solutes dissolved in the liquid to transition to a solid state. For example, the initial CO₂ sequestering solid composition can be placed on a solid surface so that it is not in contact with another liquid, e.g., so that liquid from the solid composition can evaporate and the solid composition will not gain liquid from another liquid. In some cases, the step includes ways of increasing the rate of evaporation, e.g., flowing a gas (such as, a CO₂ containing multi-component gaseous stream) past the solid composition, applying a reduced gas pressure to the solid composition, increasing the temperature of the solid composition, or a combination thereof. Flowing the gas past the solid composition can be performed, for example, with a fan. A pump, e.g., a vacuum pump, can be employed to reduce the gas pressure, thereby increasing the rate of evaporation. The temperature of the solid composition can be increased, e.g., using an electric heater or a natural gas heater, to a temperature such as ranging from 25° C. to 95° C., such as from 35° C. to 80° C. In embodiments, the setting can be done simply by air drying for 1-30 days or by drying with elevated temperature (for minutes—hours at 30-200° C.). In some instances, setting is characterized by partial mineral conversion from vaterite/ACC to calcite/aragonite (not fully converted) which prevents aggregates from falling apart when in contact with solutions.

As indicated above, the solid may be a precipitate or a product formed therefrom, e.g., an aggregate, formed object, etc. Details regarding such solids and production thereof from carbonate precipitates, e.g., as described above, may be found in U.S. Pat. Nos. 9,714,406; 10,711,236; 10,203,434; 9,707,513; 10,287,439; 9,993,799; 10,197,747; and 10,322,371; as well as published PCT Application Publication No. WO 2020/047243; the disclosures of which are herein incorporated by reference.

Where the solid is an aggregate, in some instances the aggregate is produced by a protocol in which a carbonate slurry, e.g., as described above, is introduced into a revolving drum and mixed in the revolving drum under conditions sufficient to produce a carbonate aggregate. In some instances, the carbonate slurry is introduced into the revolving drum with an aggregate substrate, e.g., a warmed aggregate such as described above, and then mixed in the revolving drum to produce a carbonate coated aggregate. In some instances, the slurry (and substrate) are introduced into the revolving drum and mixing is commenced shortly after production of the carbonate slurry, such as within 12 hours, such as within 6 hours and including within 4 hours of preparing the carbonate slurry. In some instances, the entire process (i.e., from commencement of slurry preparation to obtainment of carbonate aggregate product) is performed in 15 hours or less, such as 10 hours or less, including 5 hours or less, e.g., 3 hours or less, including 1 hour less. Further details regarding such protocols may be found in Published PCT Application Publication No. WO 2020/154518; the disclosures of which is herein incorporated by reference.

Where desired, the CO₂ sequestering solid may be cured, e.g., prior to and/or after steam treatment, as desired. In some cases, curing includes changing a compound in the initial CO₂ sequestering solid composition from a first polymorph to a second polymorph. The term “polymorph” refers to compounds that have the same empirical formula but different crystal structures. “Empirical formula” refers to the ratio of atoms in a molecule, e.g., the empirical formula of water is H₂O. Calcite, aragonite, and vaterite are polymorphs of calcium carbonate (CaCO₃) since they all have the same empirical formula of CaCO₃, but they differ from each other in crystal structure, e.g., the crystal structure space groups of calcite, aragonite, and vaterite are R3c, Pmcn, and P6₃/mmc, respectively. In some cases, the polymorph is amorphism, i.e., wherein the solid is not crystalized and instead lacks long-range order. For example, the solid might include amorphous calcium carbonate. In an exemplary embodiment, the solid includes a first polymorph of calcium carbonate and the curing step converts some or all of the first polymorph of calcium carbonate into a second polymorph of calcium carbonate. In some cases, the first crystal structure is vaterite or amorphous calcium carbonate, and the second crystal structure is aragonite or calcite. Details regarding curing and protocols therefore are further provided in U.S. Provisional Application Ser. No. 63/128,487 (attorney docket no. BLUE-048PRV; filed on Dec. 21, 2020); the disclosure of which is herein incorporated by reference.

### Concrete Dry Composites

Also provided are concrete dry composites that, upon combination with a suitable setting liquid (such as described below), produce a settable composition that sets and hardens into a concrete or a mortar. Concrete dry composites as described herein include an amount of a CO₂ sequestering solid, e.g., aggregate, e.g., as described above, and a cement, such as a hydraulic cement. The term “hydraulic cement” is employed in its conventional sense to refer to a composition which sets and hardens after combining with water or a solution where the solvent is water, e.g., an admixture solution. Setting and hardening of the product produced by combination of the concrete dry composites of the invention with an aqueous liquid results from the production of hydrates that are formed from the cement upon reaction with water, where the hydrates are essentially insoluble in water.

Aggregates produced from conditioned CO₂ containing multi-component gaseous streams, e.g., as described above, find use in place of conventional natural rock aggregates used in conventional concrete when combined with pure Portland cement. Other hydraulic cements of interest in certain embodiments are Portland cement blends. The phrase “Portland cement blend” includes a hydraulic cement composition that includes a Portland cement component and significant amount of a non-Portland cement component. As the cements of the invention are Portland cement blends, the cements include a Portland cement component. The Portland cement component may be any convenient Portland cement. As is known in the art, Portland cements are powder compositions produced by grinding Portland cement clinker (more than 90%), a limited amount of calcium sulfate which controls the set time, and up to 5% minor constituents (as allowed by various standards). When the exhaust gases used to provide carbon dioxide for the reaction contain SOx, then sufficient sulphate may be present as calcium sulfate in the precipitated material, either as a cement or aggregate to offset the need for additional calcium sulfate. As defined by the European Standard EN197.1, “Portland cement clinker is a hydraulic material which shall consist of at least two-thirds by mass of calcium silicates (3CaO.SiO₂ and 2CaO.SiO₂), the remainder consisting of aluminum- and iron-containing clinker phases and other compounds. The ratio of CaO to SiO₂ shall not be less than 2.0. The magnesium content (MgO) shall not exceed 5.0% by mass.” The concern about MgO is that later in the setting reaction, magnesium hydroxide, brucite, may form, leading to the deformation and weakening and cracking of the cement. In the case of magnesium carbonate containing cements, brucite will not form as it may with MgO. In certain embodiments, the Portland cement constituent of the present invention is any Portland cement that satisfies the ASTM Standards and Specifications of C150 (Types I-VIII) of the American Society for Testing of Materials (ASTM C50-Standard Specification for Portland Cement). ASTM C150 covers eight types of Portland cement, each possessing different properties, and used specifically for those properties.

Also of interest as hydraulic cements are carbonate containing hydraulic cements. Such carbonate containing hydraulic cements, methods for their manufacture and use are described in U.S. Pat. No. 7,735,274; the disclosure of which applications are herein incorporated by reference.

In certain embodiments, the hydraulic cement may be a blend of two or more different kinds of hydraulic cements, such as Portland cement and a carbonate containing hydraulic cement. In certain embodiments, the amount of a first cement, e.g., Portland cement in the blend ranges from 10 to 90% (w/w), such as 30 to 70% (w/w) and including 40 to 60% (w/w), e.g., a blend of 80% OPC and 20% carbonate hydraulic cement.

In some instances, the concrete dry composite compositions, as well as concretes produced therefrom, have a CarbonStar Rating (CSR) that is less than the CSR of the control composition that does not include an aggregate of the invention. The CarbonStar Rating (CSR) is a value that characterizes the embodied carbon (in the form of CaCO₃) for any product, in comparison to how carbon intensive production of the product itself is (i.e., in terms of the production CO₂). The CSR is a metric based on the embodied mass of CO₂ in a unit of concrete. Of the three components in concrete—water, cement and aggregate—cement is by far the most significant contributor to CO₂ emissions, roughly 1:1 by mass (1 ton cement produces roughly 1 ton CO₂). So, if a cubic yard of concrete uses 600 lb cement, then its CSR is 600. A cubic yard of concrete according to embodiments of the present invention which include 600 lb cement and in which at least a portion of the aggregate is carbonate coated aggregate, e.g., as described above, will have a CSR that is less than 600, e.g., where the CSR may be 550 or less, such as 500 or less, including 400 or less, e.g., 250 or less, such as 100 or less, where in some instances the CSR may be a negative value, e.g., 0 or less, such as −500 or less including −1000 or less, where in some instances the CSR of a cubic yard of concrete having 600 lbs cement may range from 500 to −5000, such as −100 to −4000, including −500 to −3000. To determine the CSR of a given cubic yard of concrete that includes calcium carbonate coated aggregate of the invention, an initial value of CO₂ generated for the production of the cement component of the concrete cubic yard is determined. For example, where the yard includes 600 lbs of cement, the initial value of 600 is assigned to the yard. Next, the amount of carbonate coating in the yard is determined. Since the molecular weight of calcium carbonate is 100 a.u., and 44% of calcium carbonate is CO₂ (mass basis), the amount of calcium carbonate coating is present in the yard is then multiplied by 0.44 and the resultant value subtracted from the initial value in order to obtain the CSR for the yard. For example, where a given yard of concrete mix is made up of 600 lbs of cement, 300 lbs of water, 1429 lbs of fine aggregate and 1739 lbs of coarse aggregate, the weight of a yard of concrete is 4068 lbs and the CSR is 600. If 10% of the total mass of aggregate in this mix is replaced by carbonate coating, e.g., as described above, the amount of carbonate present in the revised yard of concrete is 317 lbs. Multiplying this value by 0.44 yields 139.5. Subtracting this number from 600 provides a CSR of 460.5. More detail about the specifications of CarbonStar are in CSA SPE-112, CarbonStar®: Technical specification for concrete carbon intensity quantification and verification, published by the Canadian Standards Association (CSA) in 2021; the disclosure of which is herein incorporated by reference.

### Settable Compositions

Settable compositions of the invention, such as concretes and mortars, are produced by combining a hydraulic cement with an amount of aggregate (fine for mortar, e.g., sand; coarse with or without fine for concrete) and water, either at the same time or by pre-combining the cement with aggregate, and then combining the resultant dry components with water. The choice of coarse aggregate material for concrete mixes using cement compositions of the invention may have a minimum size of about ⅜ inch and can vary in size from that minimum up to one inch or larger, including in gradations between these limits. Finely divided aggregate is smaller than ⅜ inch in size and again may be graduated in much finer sizes down to 200-sieve size or so. Fine aggregates may be present in both mortars and concretes of the invention. The weight ratio of cement to aggregate in the dry components of the cement may vary, and in certain embodiments ranges from 1:10 to 4:10, such as 2:10 to 5:10 and including from 55:1000 to 70:100.

The liquid phase, e.g., aqueous fluid, with which the dry component is combined to produce the settable composition, e.g., concrete, may vary, from pure water to water that includes one or more solutes, additives, co-solvents, etc., as desired. The ratio of dry component to liquid phase that is combined in preparing the settable composition may vary, and in certain embodiments ranges from 2:10 to 7:10, such as 3:10 to 6:10 and including 4:10 to 6:10.

In certain embodiments, the cements may be employed with one or more admixtures. Admixtures are compositions added to concrete to provide it with desirable characteristics that are not obtainable with basic concrete mixtures or to modify properties of the concrete to make it more readily useable or more suitable for a particular purpose or for cost reduction. As is known in the art, an admixture is any material or composition, other than the hydraulic cement, aggregate and water, that is used as a component of the concrete or mortar to enhance some characteristic, or lower the cost, thereof. The amount of admixture that is employed may vary depending on the nature of the admixture. In certain embodiments the amounts of these components range from 1 to 50% w/w, such as 2 to 10% w/w.

Admixtures of interest include finely divided mineral admixtures such as cementitious materials; pozzolans; pozzolanic and cementitious materials; and nominally inert materials. Pozzolans include diatomaceous earth, opaline cherts, clays, shales, fly ash, silica fume, volcanic tuffs and pumicites are some of the known pozzolans. Certain ground granulated blast-furnace slags and high calcium fly ashes possess both pozzolanic and cementitious properties. Nominally inert materials can also include finely divided raw quartz, dolomites, limestone, marble, granite, and others. Fly ash is defined in ASTM C618.

Other types of admixture of interest include plasticizers, accelerators, retarders, air-entrainers, foaming agents, water reducers, corrosion inhibitors, and pigments.

As such, admixtures of interest include, but are not limited to: set accelerators, set retarders, air-entraining agents, defoamers, alkali-reactivity reducers, bonding admixtures, dispersants, coloring admixtures, corrosion inhibitors, dampproofing admixtures, gas formers, permeability reducers, pumping aids, shrinkage compensation admixtures, fungicidal admixtures, germicidal admixtures, insecticidal admixtures, rheology modifying agents, finely divided mineral admixtures, pozzolans, aggregates, wetting agents, strength enhancing agents, water repellents, and any other concrete or mortar admixture or additive. Admixtures are well-known in the art and any suitable admixture of the above type or any other desired type may be used; see, e.g., U.S. Pat. No. 7,735,274, incorporated herein by reference in its entirety.

In some instances, the settable composition is produced using an amount of a bicarbonate rich product (BRP) admixture, which may be liquid or solid form, e.g., as described in U.S. patent application Ser. No. 14/112,495 published as United States Published Application Publication No. 2014/0234946; the disclosure of which is herein incorporated by reference.

In certain embodiments, settable compositions of the invention include a cement employed with fibers, e.g., where one desires fiber-reinforced concrete. Fibers can be made of zirconia containing materials, steel, carbon, fiberglass, or synthetic materials, e.g., polypropylene, nylon, polyethylene, polyester, rayon, high-strength aramid (i.e. Kevlar®), or mixtures thereof.

The components of the settable composition can be combined using any convenient protocol. Each material may be mixed at the time of work, or part of or all of the materials may be mixed in advance. Alternatively, some of the materials are mixed with water with or without admixtures, such as high-range water-reducing admixtures, and then the remaining materials may be mixed therewith. As a mixing apparatus, any conventional apparatus can be used. For example, Hobart mixer, slant cylinder mixer, Omni Mixer, Henschel mixer, V-type mixer, and Nauta mixer can be employed.

Following the combination of the components to produce a settable composition (e.g., concrete), the settable composition are in some instances initially flowable compositions, and then set after a given period of time. The setting time may vary, and in certain embodiments ranges from 30 minutes to 48 hours, such as 30 minutes to 24 hours and including from 1 hour to 4 hours.

The strength of the set product may also vary. In certain embodiments, the strength of the set cement may range from 5 Mpa to 70 MPa, such as 10 MPa to 50 MPa and including from 20 MPa to 40 MPa. In certain embodiments, set products produced from cements of the invention are extremely durable. e.g., as determined using the test method described at ASTM C1157.

### Structures

Aspects of the invention further include structures produced from the aggregates and settable compositions of the invention. As such, further embodiments include manmade structures that contain the aggregates of the invention and methods of their manufacture. Thus, in some embodiments the invention provides a manmade structure that includes one or more aggregates as described herein. The manmade structure may be any structure in which an aggregate may be used, such as a building, dam, levee, roadway or any other manmade structure that incorporates an aggregate or rock. In some embodiments, the invention provides a manmade structure, e.g., a building, a dam, or a roadway, that includes an aggregate of the invention that contains CO₂ from a fossil fuel source. In some embodiments the invention provides a method of manufacturing a structure, comprising providing an aggregate of the invention that contains CO₂ from a fossil fuel source. Because these structures are produced from aggregates and/or settable compositions of the invention, they will include markers or components that identify them as being produced by a bicarbonate mediated CO₂ sequestration protocol.

### Utility

The subject solid, e.g., aggregate, compositions and settable compositions that include the same, find use in a variety of different applications, such as above ground stable CO₂ sequestration products, as well as building or construction materials. Specific structures in which the settable compositions of the invention find use include, but are not limited to: pavements, architectural structures, e.g., buildings, foundations, motorways/roads, overpasses, bridges, parking structures, brick/block walls and footings for gates, fences and poles. Mortars of the invention find use in binding construction blocks, e.g., bricks, together and filling gaps between construction blocks. Mortars can also be used to fix existing structure, e.g., to replace sections where the original mortar has become compromised or eroded, among other uses.

### Systems

Also provided are systems for performing the methods described herein. For example, in some cases the system includes a CO₂ comprising multicomponent gaseous stream conditioning module for conditioning a CO₂ comprising multi-component gaseous stream, e.g., by an embodiment of the invention, such as described above. Where desired, the system can also include a CO₂ sequestering solid composition preparation module, e.g., which is operably connected to the conditioning module. The CO₂ sequestering solid composition preparation module, when present, may be configured to prepare a solid composition, e.g., as described above and, in some instances, includes an intake for a conditioned CO₂ containing multi-component gaseous stream, an intake for an aqueous capture liquid, and output for the initial CO₂ sequestering solid composition. The module may be configured to contact a conditioned CO₂-containing gas with an aqueous capture liquid and a cation source and produce the initial CO₂ sequestering solid composition. In some cases, this production includes a first section of the module wherein the aqueous capture liquid is contacted with the gaseous source of CO₂ to produce an aqueous liquid, and a second section of the module wherein the aqueous liquid is contacted with a cation source to produce the initial CO₂ sequestering solid composition. In other cases, the production includes contacting aqueous capture liquid comprising a cation source with a gaseous source of CO₂ to produce the initial CO₂ sequestering solid composition. In such a case, the cation source is a part of the capture liquid before the capture liquid is contacted with the gaseous source of CO₂.

Each of the modules can be independently configured for batch operation or continuous operation, i.e., flow operation. In batch operation, a certain amount of compounds are mixed together in the module, the compounds are allowed to react for a certain amount of time without new compounds being added, and then the products are removed from the module. For example, if a curing module is configured for batch operation, the initial CO₂ sequestering solid composition and curing liquid are added to the module, and the resulting cured CO₂ sequestering solid is removed from the module before additional initial CO₂ sequestering solid composition is added. In continuous operation or flow operation, the inputs are continuously flowed into the module and the outputs are continuously flowed out of the module.

In some cases, the system also includes an aqueous capture ammonia regeneration module configured to supply aqueous capture ammonia to the aggregate composition preparation module. In some cases, the regeneration module is configured to produce the ammonia by distillation. In some cases, the regeneration module is configured to produce the ammonia by contacting an ammonium salt with an alkalinity source. Exemplary methods of using aqueous capture ammonia in such a manner are described in U.S. Pat. No. 10,322,371, which is incorporated herein by reference. In some cases the ammonia is regenerated with geomass, e.g., minerals obtained from the earth, as described in PCT Publication WO 2020/047243, which is incorporated herein by reference.

The following examples are offered by way of illustration and not by way of limitation.

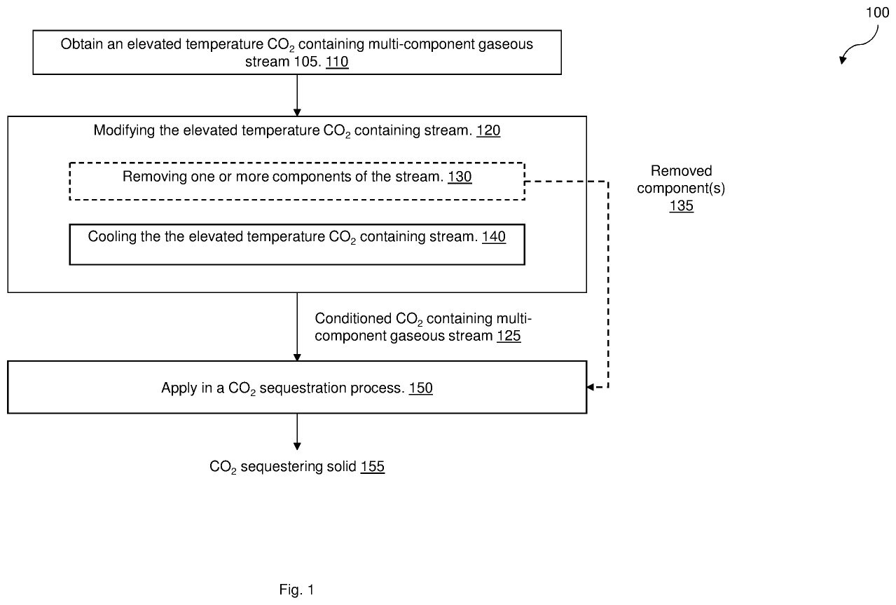

FIG. 1 illustrates a method 100 for conditioning an elevated temperature CO₂ containing multi-component gaseous stream for use in a CO₂ sequestration process according to one embodiment. At block 110, an elevated temperature CO₂ containing multi-component gaseous stream 105 is obtained. For example, elevated temperature flue gas is obtained directly from an industrial plant, such as a power plant. At block 120, the gaseous stream 105 is modified. Optionally, at block 130, the modifying includes removing one or more physical components of the gaseous stream 105. Accordingly, one or more of moisture, particulates, and pollutants 135 is removed from the gaseous stream 105. In some embodiments, the modifying includes removing heat and thereby cooling (block 140) the gaseous stream 105. The output of block 120 is a conditioned CO₂ containing multi-component gaseous stream 125. In some embodiments, this output is input to a CO₂ sequestration process 150, in order to produce a CO₂ sequestering solid 155. As shown in FIG. 1, one or more the removed physical components 135 is employed in the CO₂ sequestration process 150. For example, particulates removed from the elevated temperature CO₂ containing multi-component gaseous stream 105 may be employed in the CO₂ sequestration process 150 as small particle aggregate input.

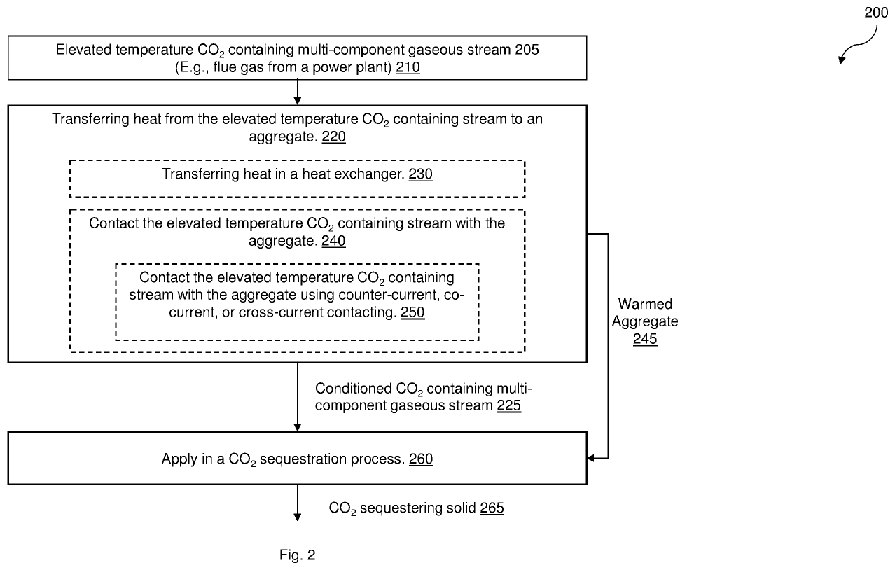

FIG. 2 illustrates a method 200 for conditioning an elevated temperature CO₂ containing multi-component gaseous stream for use in a CO₂ sequestration process according to one embodiment. At block 210, an elevated temperature CO₂ containing multi-component gaseous stream 205 is obtained. For example, elevated temperature flue gas is obtained directly from an industrial plant, such as a power plant. At block 220, the gaseous stream 205 is modified by removing heat and thereby cooling the gaseous stream 205. In some embodiments, the heat removal is accomplished by transferring at least some of the heat from the elevated temperature CO₂ containing multi-component gaseous stream 205 to aggregate, such as geomass, or CaCO₃ aggregate. In some embodiments, optionally, the heat transfer is accomplished in a heat exchanger (block 230). In some embodiments, optionally, the heat transfer is accomplished by contacting the elevated temperature CO₂ containing multi-component gaseous stream 205 with aggregate (block 240). The contact can be accomplished using counter-current, co-current, or cross-current contacting (block 250). The output of block 220 is a conditioned CO₂ containing multi-component gaseous stream 225 as well as warmed aggregate 245. In some embodiments, both outputs are input to a CO₂ sequestration process 260, in order to produce a CO₂ sequestering solid 265.

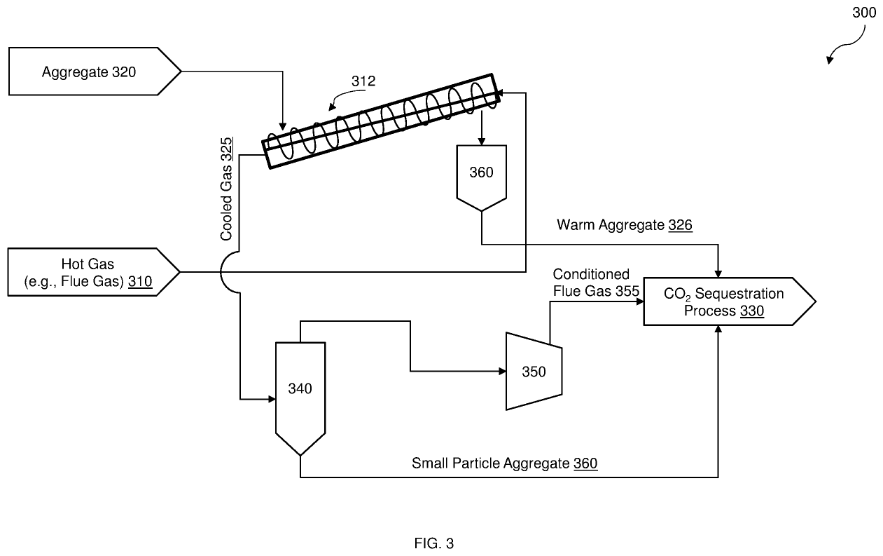

FIG. 3 illustrates one embodiment of a system 300 for conditioning an elevated temperature CO₂ containing multi-component gaseous stream 310 for use in a CO₂ sequestration process. Multi-component gaseous stream 310 (such as, hot flue gas from an industrial plant) is cooled by contact with a (relatively cold) upcycled aggregate 320 using a heat exchanger 312 to generate cooled CO₂ containing multi-component gaseous stream 325. While the example depicted in FIG. 3 illustrates a counter-current heat exchanger system 312, a cross-current or a co-current heat exchanger system can also be used. Transferring heat from the hot gas stream 310 to the aggregate 320 results in the production of a warmed aggregate 326. The warmed aggregate 326 flows into a feed hopper 360 before being employed in a CO₂ sequestration process 330. As shown, the cooled CO₂ containing multi-component gaseous stream 325 is passed through a filter 340 (e.g., a baghouse) to remove particulates prior to boosting its pressure using compressor 350 for use in the CO₂ sequestration process 330. The particulates that are filtered out are used as small particle aggregate 360 and also used as an input to the CO₂ sequestration process 330.

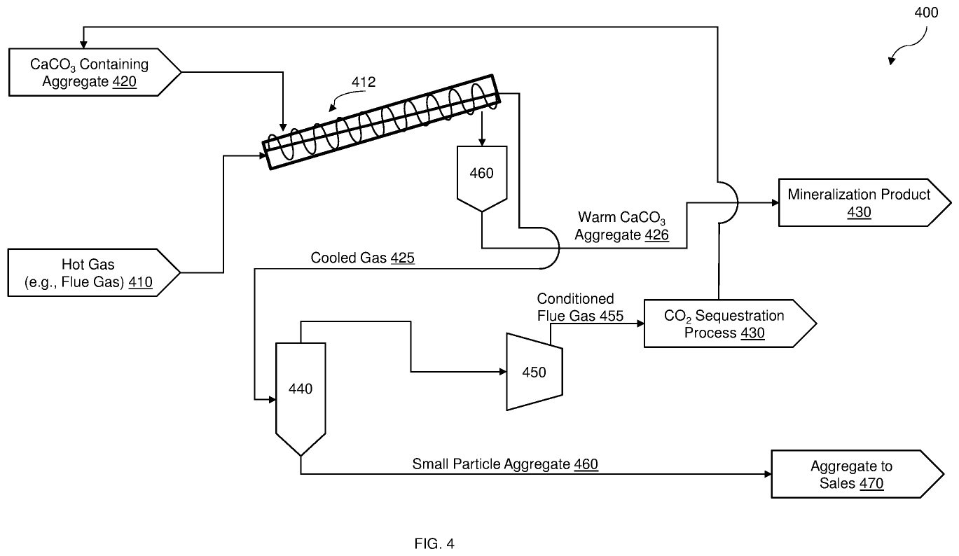

FIG. 4 illustrates another embodiment of a system 400 for conditioning an elevated temperature CO₂ containing multi-component gaseous stream 410 for use in a CO₂ sequestration process. Multi-component gaseous stream 410 (such as, hot flue gas from an industrial plant) is cooled by contact with a (relatively cold) calcium carbonate (CaCO₃) containing aggregate 420 using a heat exchanger 412 to generate cooled CO₂ containing multi-component gaseous stream 425. While the example depicted in FIG. 4 illustrates a co-current heat exchanger system 412, a cross-current or a counter-current heat exchanger system can also be used. Transferring heat from the hot gas stream 410 to the calcium carbonate aggregate 420 results in the production of a warmed calcium carbonate aggregate 426. The warmed calcium carbonate aggregate 426 flows into a feed hopper 460 before being employed as a mineralization product 430. As shown, the cooled CO₂ containing multi-component gaseous stream 425 that is an output of the heat exchanger system 412 is passed through a filter 440 (e.g., a baghouse) to remove particulates prior to boosting its pressure using compressor 450 for use in the CO₂ sequestration process 430. The particulates that are filtered out are used as small particle aggregate 460, which can be sold, e.g., as an ingredient of concrete.

In at least some of the previously described embodiments, one or more elements used in an embodiment can interchangeably be used in another embodiment unless such a replacement is not technically feasible. It will be appreciated by those skilled in the art that various other omissions, additions and modifications may be made to the methods and structures described above without departing from the scope of the claimed subject matter. All such modifications and changes are intended to fall within the scope of the subject matter, as defined by the appended claims.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible sub-ranges and combinations of sub-ranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into sub-ranges as discussed above. Finally, as will be understood by one skilled in the art, a range includes each individual member. Thus, for example, a group having 1-3 articles refers to groups having 1, 2, or 3 articles. Similarly, a group having 1-5 articles refers to groups having 1, 2, 3, 4, or 5 articles, and so forth.

Although the foregoing invention has been described in some detail by way of illustration and example for purposes of clarity of understanding, it is readily apparent to those of ordinary skill in the art in light of the teachings of this invention that certain changes and modifications may be made thereto without departing from the spirit or scope of the appended claims.

Accordingly, the preceding merely illustrates the principles of the invention. It will be appreciated that those skilled in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. Moreover, nothing disclosed herein is intended to be dedicated to the public regardless of whether such disclosure is explicitly recited in the claims.

The scope of the present invention, therefore, is not intended to be limited to the exemplary embodiments shown and described herein. Rather, the scope and spirit of present invention is embodied by the appended claims. In the claims, 35 U.S.C. § 112(f) or 35 U.S.C. § 112(6) is expressly defined as being invoked for a limitation in the claim only when the exact phrase “means for” or the exact phrase “step for” is recited at the beginning of such limitation in the claim; if such exact phrase is not used in a limitation in the claim, then 35 U.S.C. § 112 (f) or 35 U.S.C. § 112(6) is not invoked.

1. A method of conditioning an elevated temperature CO₂ containing multi-component gaseous stream for use in a CO₂ sequestration process, the method comprising:
modifying the elevated temperature CO₂ containing multi-component gaseous stream, including removing heat from elevated temperature CO₂ containing multi-component gaseous stream to condition the elevated temperature CO₂ containing multi-component gaseous stream for use in a CO₂ sequestration process.

2. The method according to claim 1, wherein removing heat comprises contacting the CO₂ containing multi-component gaseous stream in a heat exchanger.

3. The method according to claim 2, wherein removing heat comprises contacting the CO₂ containing multi-component gaseous stream with an aggregate.

4. The method according to claim 2, wherein removing heat comprises contacting the CO₂ containing multi-component gaseous stream with a CaCO₃ aggregate.

5. The method according to claim 1, wherein the modifying further comprising removing one or more physical components of the CO₂ containing multi-component gaseous stream.

6. The method according to claim 5, wherein the one or more physical components include moisture (H₂O), particulates, pollutants and combinations thereof.

7. The method according to claim 1, wherein the method further comprises preparing a CO₂ sequestering solid from the conditioned CO₂ containing multi-component gaseous stream.

8. The method according to claim 5, wherein the method comprising employing one or more of the removed physical components in the CO₂ sequestration process.

9. The method according to claim 1, wherein the CO₂ containing multi-component gaseous stream comprises a flue gas from an industrial plant.

10. The method according to claim 1, wherein the elevated temperature CO₂ containing multi-component gaseous stream has a temperature of 150° F. or higher.

11. The method according to claim 10, wherein the elevated temperature CO₂ containing multi-component gaseous stream has a temperature of 200° F. or higher.

12. The method according to claim 3, wherein the aggregate has a starting temperature ranging from 32 to 100° F.

13. The method according to claim 3, wherein the contacting of elevated temperature CO₂ containing multi-component gaseous stream with the aggregate comprises counter-current contacting.

14. The method according to claim 3, wherein the contacting of elevated temperature CO₂ containing multi-component gaseous stream with the aggregate comprises co-current contacting.

15. The method according to claim 3, wherein the contacting of elevated temperature CO₂ containing multi-component gaseous stream with the aggregate comprises cross-current contacting.

16. The method according to claim 3, further comprising producing a warmed aggregate.

17. The method according to claim 16, wherein the warmed aggregate has a temperature ranging from 65 to 120° F.

18. The method according to claim 16, further comprising employing the warmed aggregate in a CO₂ sequestration process.

19. The method according to claim 18, wherein the CO₂ sequestration process comprises associating the warmed aggregate with a CO₂ sequestering carbonate mineral.
